(19) United States
(12) Patent Application Publication
(10) Pub. No.: US 2023/0247605 A1
(43) Pub. Date: Aug. 3, 2023

(54) UPLINK PROCESSING METHOD AND APPARATUS

(71) Applicant: JRD COMMUNICATION (SHENZHEN) LTD., Shenzhen, Guangdong (CN)

(72) Inventors: Tian Li, Shenzhen, Guangdong (CN); Jia SHENG, Shenzhen, Guangdong (CN)

(73) Assignee: JRD COMMUNICATION (SHENZHEN) LTD., Shenzhen, Guangdong (CN)

(21) Appl. No.: 17/996,160

(22) PCT Filed: Apr. 14, 2020
(86) PCT No.: PCT/CN2020/084768

§ 371 Date: Oct. 13, 2022

(51) Int. Cl. H04W 72/0453

(52) U.S. Cl. CPC H04W 72/0453

(57) ABSTRACT

An uplink processing method for multiple transmission and reception point (TRP) based communication executable by a user equipment. A frequency point of one of a paired uplink TRP and a downlink TRP is directly obtained from the parameters of a bandwidth part (BWP) in a serving cell. A frequency point of the other one of the paired uplink TRP and the downlink TRP is directed obtained from the frequency point of one of a paired uplink TRP and a downlink TRP.

### TECHNICAL FIELD

The present disclosure relates to the field of multiple input multiple output (MIMO) communication systems, and more particularly, to an apparatus and a method for improving of uplink channel procedures in a multiple transmission-reception point (multi-TRP) scenario.

### BACKGROUND ART

Multiple input multiple output (MIMO) exploits of radio link capacity using multiple transmission antennas at a transmitter side and multiple receiving antennas at a receiver side. MIMO realizes spatial multiplexing to greatly improve spectral efficiency.

In radio access network working group RAN1 #95 meeting of 3rd Generation Partnership Project (3GPP), two different downlink control information (DCI) schemes have been agreed for supporting multi-TRP/panel transmission in new radio (NR):

First Scheme: Single new radio physical downlink control channel (NR-PDCCH) schedules single NR-PDSCH, where separate layers are transmitted from separate TRPs.

Second scheme: Multiple NR-PDCCHs are used for NR-PDSCH scheduling. Each NR-PDCCH scheduling one of a plurality of NR-PDSCHs is transmitted from a separate TRP.

With reference to FIG. 1, in the second scheme, two NR-PDCCHs from separate TRPs, such as TRP1 and TRP2, independently schedule two corresponding new radio physical downlink shared channels (NR-PDSCHs), such as PDSCH1 and PDSCH2, to a user equipment (UE) 111. That is, the NR-PDCCHs carrying downlink control information, such as DCI1 and DCI2, may be scheduled independently from two TRPs. The second scheme is beneficial especially when different TRPs are connected by non-ideal backhaul. In the multi-TRP transmission, joint scheduling may be limited or even not feasible due to delay of inter-TRP signaling, such as channel state information (CSI), scheduling signals, and data, in non-ideal backhaul.

When independent radio resource scheduling via control information are needed at each TRP, the second scheme with multiple PDCCHs can also be useful. Using separate DCI for independently scheduling different modulation and coding schemes (MCSs) for PDSCHs may improve performance. Further, scheduling different codewords at each TRP may also improve performance.

In Rel-16 of 3GPP NR standards, single PDCCH-based and multiple PDCCHs-based multi-TRP transmission have been adopted for non-coherent joint transmission (NC-JT). In single PDCCH-based multi-TRP transmission, single PDCCH is used to schedule single PDSCH from multi-TRPs. However, multiple PDCCH-based multi-TRP transmission, multiple PDCCHs are used for PDSCH scheduling, where each PDSCH is transmitted from a separate TRP.

For downlink transmission, a specific TRP can be identified by a higher layer index which is configured per ControlResourceSet (CORESET). The index may be used as an identifier of a TRP and is referred to as CORESETPoolIndex. The CORESETPoolIndex may be contained in CORESET. If being configured with two different values of CORESETPoolIndex for an active bandwidth part (BWP) of a serving cell, a UE is expected to communicate with two different TRPs.

### Technical Problem

In Rel-16, the maximum number of CORESETs that can be configured with the same TRP is 3, and the maximum number of CORESETs that can be configured within a cell is 5. For downlink (DL) transmission, these CORESETs are divided into two groups, and each group is associated with a specific TRP through the higher layer parameter CORESETPoolIndex in an active BWP. However, for uplink (UL) transmission, two UL TRPs may be allocated in one UL BWP, and more UL TRPs may be allocated within a cell. A UE need to identify a destination UL TRP among the TRPs for uplink transmission. Hence, to differentiating and identifying the UL TRPs is necessary. Further, TRP ID numbering is also essential for UL TRPs.

### SUMMARY

### Technical Solution

An object of the present disclosure is to propose an uplink processing method and an apparatus to address the problems in multiple transmission and reception point (TRP) based communication.

In a first aspect of the present disclosure, an uplink processing method for multiple transmission and reception point (TRP) based communication is executable by a user equipment and includes: receiving parameters of a bandwidth part (BWP) in a serving cell; obtaining a frequency point of one of a paired uplink TRP and a downlink TRP from the parameters of BWP; and obtaining a frequency point of the other one of the paired uplink TRP and the downlink TRP from the frequency point of one of a paired uplink TRP and a downlink TRP.

In a second aspect of the present disclosure, an apparatus including a transceiver and a processor connected with the transceiver. The processor is configured to execute the following steps comprising: receiving parameters of a bandwidth part (BWP) in a serving cell; obtaining a frequency point of one of a paired uplink TRP and a downlink TRP from the parameters of BWP; and obtaining a frequency point of the other one of the paired uplink TRP and the downlink TRP from the frequency point of one of a paired uplink TRP and a downlink TRP.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as computer program product, that causes a computer to execute the disclosed method.

The disclosed method may be programmed as computer program, that causes a computer to execute the disclosed method.

### Advantageous Effects

Without the proposed method for uplink transmission, the transmitter may be confused with the mismatched TRP ID and the frequency points for the unpaired TRPs. Without the association to a new BWP during BWP switching, PDCCH monitoring may be more time consumptive.

Without the alignment between UL TRP and DL TRP, uplink and downlink may be carried in unpaired frequency points. Additionally, without the TRP ID pairing, the UL TRP and DL TRP may not be provided the available resource.

The disclosure provides various embodiments of an apparatus and a method to support of uplink transmission in multi-DCI based multi-TRP/panel scenarios.

A UE need to identify one of the UL TRPs for uplink transmission. The disclosed method uses CORESET grouping indices as TRP IDs to differentiate and identify UL TRPs. The frequency points for UL TRP and DL TRP may not be aligned and cause unpaired UL and DL spectrum. Two embodiments of the disclosed method are proposed to align and match frequency points for UL TRP and DL TRP, including center frequency points, and upper limit frequency points. As multiple TRPs can be allocated in a cell, two embodiments of the disclosed methods are proposed to number TRP IDs, including local TRP ID numbering and global TRP ID numbering. In the disclosure, the UL TRP ID of a specific TRP is the same as the DL TRP ID of the specific TRP. Additionally, during BWP switching from an original BWP to a new BWP, the frequency points, CORESETPoolIndex and TRP IDs of a couple of paired UL TRP and DL TRP can be immediately aligned in the new BWP. Thus, resource allocation efficiency for the paired UL TRP and DL TRP can be improved.

### DESCRIPTION OF DRAWINGS

In order to more clearly illustrate the embodiments of the present disclosure or related art, the following FIG.s will be described in the embodiments are briefly introduced. It is obvious that the drawings are merely some embodiments of the present disclosure, a person having ordinary skill in this field can obtain other FIG.s according to these figures.

FIG. 1 is a schematic diagram showing a multiple transmission and reception point (TRP) architecture.

FIG. 2 is a block diagram of a user equipment (UE), two base stations (BSs) according to an embodiment of the present disclosure.

FIG. 3 is a schematic diagram showing an uplink processing method according to an embodiment of the present disclosure.

FIG. 4 is a schematic diagram showing ControlResourceSets (CORESETs) and CORESETgroup indices.

FIG. 5 is a schematic diagram showing center frequency points matching.

FIG. 6 is a schematic diagram showing upper limit frequency points matching.

FIG. 7 is a schematic diagram showing center frequency points matching with fully overlapped frequency resources.

FIG. 8 is a schematic diagram showing local TRP ID pairing.

FIG. 9 is a schematic diagram showing global TRP ID pairing.

FIG. 10 is a schematic diagram showing TRP ID pairing in switching of bandwidth parts (BWPs).

FIG. 11 is a schematic diagram showing an example of TRP ID pairing in switching of bandwidth parts (BWPs).

FIG. 12 is a schematic diagram showing another example of TRP ID pairing in switching of bandwidth parts (BWPs).

FIG. 13 is a block diagram of a system for wireless communication according to an embodiment of the present disclosure.

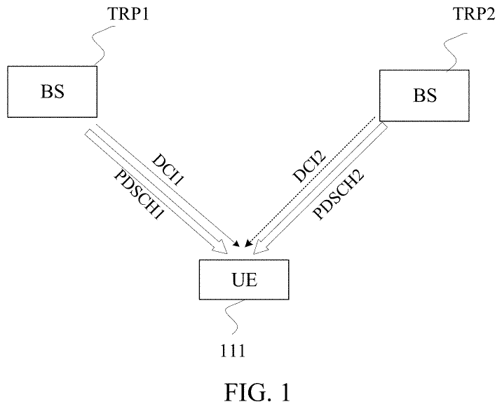

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Currently, a transmitter and a receiver should identify the TRP IDs for downlink and uplink transmission in multi-DCIs based multi-TRP/panel transmission scenario. Since the uplink and downlink can be scheduled independently, the frequency points of an UL TRP and a DL TRP may be mismatched. Hence, a method for specifying relationship between unpaired UL and DL frequencies is needed. Additionally, as multiple TRPs can be allocated in a cell, a method for TRP ID numbering and TRP ID pairing is needed.

For unpaired UL and DL spectrum, a DL BWP from the set of configured DL BWPs with index provided by a higher layer parameter BWP-Id is linked with an UL BWP from the set of configured UL BWPs with index provided by a higher layer parameter BWP-Id when the DL BWP index and the UL BWP index are same. When the BWP-Id of the DL BWP is same as the BWP-Id of the UL BWP, a UE cannot operate correctly with a configuration where the center frequency for a DL BWP is different from the center frequency for an UL BWP. That is, a UE is provided with an assumption that the center frequency for DL TRP matches the center frequency for UL TRP. In multi-DCIs based multi-TRP transmission, a UE may be allocated with two potential TRP IDs. As the TRP ID is determined by scheduling CORESET, center frequencies of UL and DL TRPs may be mismatched.

The disclosure provides reliability features to improve MIMO techniques targeting both FR1 and FR2, thus to improve reliability and robustness for PDCCH, PUSCH, and PUCCH in multi-TRP deployment. The disclosed method may identify an TRP ID for an UL TRP for uplink transmission in multiple PDCCH-based multi-TRP transmission.

Regarding multi-DCIs based multi-TRP transmission, four solutions are proposed to support PUSCH procedures, including TRP ID identification for PUSCH, frequency domain alignment, TRP IDs pairing and TRPs mapping.

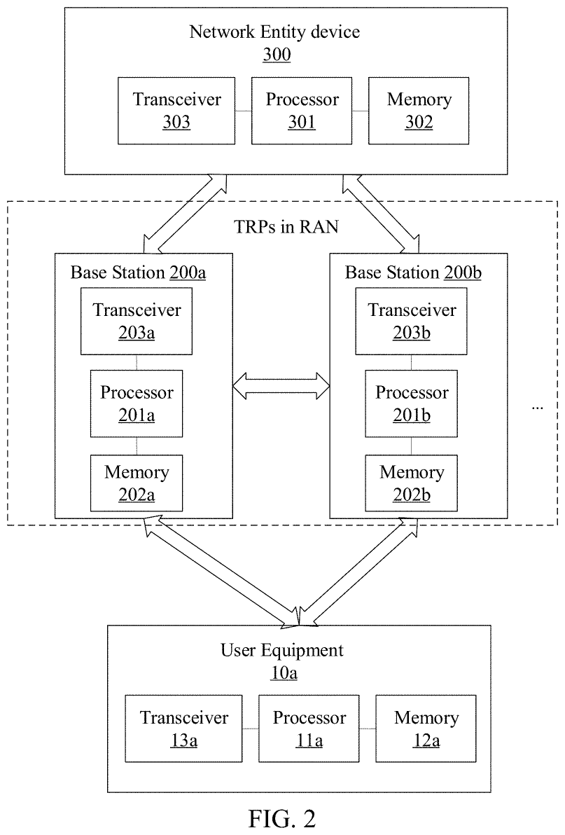

With reference to FIG. 2, a UE 10a, a base station 200a, a base station 200b, and a network entity device 300 executes an uplink processing method according to an embodiment of the present disclosure. Connections between devices and device components are shown as lines and arrows in the FIG. 2. The UE 10a may include a processor 11a, a memory 12a, and a transceiver 13a. The base station 200a may include a processor 201a, a memory 202a, and a transceiver 203a. The base station 200b may include a processor 201b, a memory 202b, and a transceiver 203b. The network entity device 300 may include a processor 301, a memory 302, and a transceiver 303. Each of the processors 11a, 201a, 201b, and 301 may be configured to implement proposed functions, procedures and/or methods described in this description. Layers of radio interface protocol may be implemented in the processors 11a, 201a, 201b, and 301. Each of the memory 12a, 202a, 202b, and 302 operatively stores a variety of program and information to operate a connected processor. Each of the transceiver 13a, 203a, 203b, and 303 is operatively coupled with a connected processor, transmits and/or receives a radio signal. Each of the base stations 200a and 200b may be an eNB, a gNB, or one of other radio nodes.

Each of the processor 11a, 201a, 201b, and 301 may include a general purpose central processing unit (CPU), an application-specific integrated circuits (ASICs), other chipsets, logic circuits and/or data processing devices. Each of the memory 12a, 202a, 202b, and 302 may include a read-only memory (ROM), a random access memory (RAM), a flash memory, a memory card, a storage medium and/or other storage devices. Each of the transceiver 13a, 203a, 203b, and 303 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 300 may be a node in a CN. CN may include LTE CN or 5GC which may include user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

TRP identification is detailed in the following.

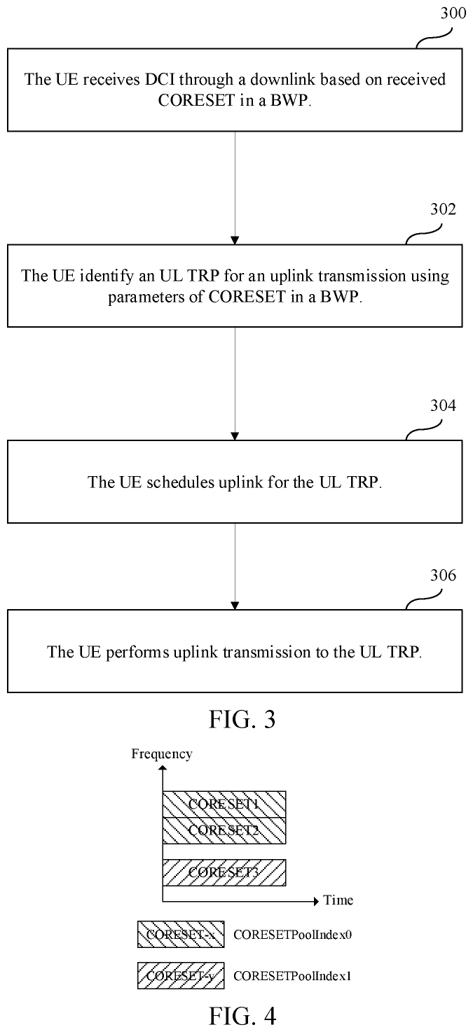

With reference to FIGS. 2 and 3, for example, base stations 200a and 200b may serve as TRP1 and TRP2 dedicated to the UE, such as UE 10a. Alternative, more TRPs may be allocated to the UE. In multi-PDCCH based multi-TRP operation, the maximum number of CORESETs per BWP configured to a UE is five, and each CORESET may be associated with a TRP. These CORESETs can be allocated to multiple groups, and each group is associated to a dedicated TRP.

A TRP transmits DCI through a PDCCH in CORESET in BWP to the UE. The UE monitors PDCCH candidates in common search spaces sets or UE specific search spaces sets, which are configured by higher layer parameter PDCCH-Config. Time and frequency domain resources of the search space sets are indicated by corresponding CORESET. The UE obtains search space sets from the CORESET to monitor the PDCCH and obtains UL DCI, such as DCI0_0, DCI0_1, and DCI0_2, in the PDCCH. When successfully detecting the UL DCI (block 300), the UE identifies one or more UL TRPs (block 302), and schedules one or more dedicated PUSCHs for the UL TRPs (block 304). The UE can identify a dedicated TRP for one PUSCH. Alternatively, the UE may identify a plurality of different TRPs for PUSCHs, and schedule multiple PUSCH transmissions overlapped in time domain to the different TRPs. The UE performs uplink transmission to the identified one or more UL TRPs (block 306).

Based on the relationship between PUSCH and CORESET, the UE may identify a dedicated TRP for PUSCH using a CORESET grouping index, such as CORESETPoolIndex, of the dedicated TRP. The CORESET grouping index, such as CORESETPoolIndex, is contained in a higher layer parameter ControlResourceSet. Specifically, if CORESETPoolIndex is not configured, the UE may determine that only one TRP is allocated to the UE, and the TRP ID is 0.

With reference to FIG. 4, three CORESETs from CORESET1 to CORESET3 are configured and allocated to two groups. CORESET #1 and CORESET #2 are assigned to group #1 associated with CORESET grouping index CORESETPoolIndex0, and CORESET #3 is assigned to group #2 associated with CORESET grouping index CORESETPoolIndex1. Group #1 is associated with TRP1, and group #2 is associated with TRP2. The UE can thus transmit two PUSCHs to two different TRPs independently, even if the PUSCH are overlapped in time domain.

Frequency domain alignment for UL and DL TRP is detailed in the following.

For example, N TRPs for an active UL/DL BWP of a serving cell, and each TRP corresponds to a frequency point which is associated to the CORESET grouping index. N is a single or plural positive integer representing a total number of TRPs in the active BWP. Since uplink transmission and downlink transmission can be performed independently, the scheduling CORESET grouping indices and frequency points for uplink and downlink may be different, and result in mismatched UL and DL frequency points or unpaired spectrum for UL TRP and DL TRP operation, and the channel reciprocity cannot be obtained. To address this issue, three embodiments of the disclosed method are proposed in the following, including center frequency points matching, upper limit frequency point matching, and center frequency matching with fully overlapped frequency resources. For example, the base stations 200a and 200b, and the UE 10a may determine TRP IDs and TRP frequencies for UL and DL TRPs according to the embodiments.

Center frequency points matching is detailed in the following.

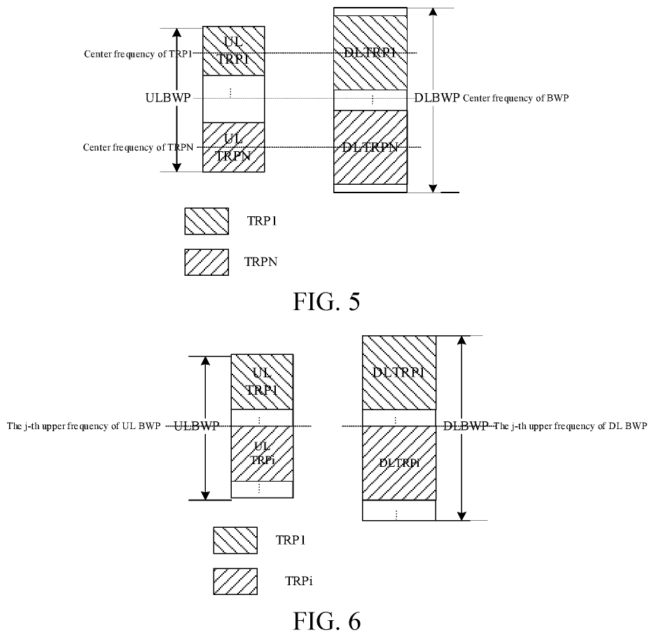

A center frequency of an active UL BWP may be the same as a center frequency of active DL BWP. To address the problem of UL and DL frequency points misalignment for a specific TRP, in the disclosed method, the center frequency of an UL TRP is the same as the center frequency of a DL TRP associated with the UL TRP. That is, a TRP pair includes the UL TRP and the DL TRP for a dedicated TRP where the UL TRP and the DL TRP have the same center frequency. A DL TRP with an TRP ID in the DL BWP j forms a paired TRP of an UL TRP with the same TRP ID in the UL BWP j. An UL TRP with the TRP ID in the UL BWP j forms a paired TRP of a DL TRP with the same TRP ID in the DL BWP j. With reference to FIG. 5, the base stations 200a and 200b, and the UE 10a may determine a set of center frequencies, such as center frequencies of UL TRP1, DL TRP1 . . . UL TRPN and DL TRPN, from corresponding configuration of an active UL BWP and an active DL BWP. For example, a center frequency of the UL TRP1 can be calculated as:

F_{CenterFreTRP1_UL}=startingPRB_{UL}+floor(nrofPRB_{UL}/2N) (1)

A center frequency of the DL TRP1 can be calculated as:

F_{CenterFreTRP1_DL}=startingPRB_{DL}+floor(nrofPRB_{DL}/2N) (2)

A center frequency of an UL TRPi can be calculated as:

F_{CenterFreTRPi_UL}=startingPRB_{UL}+floor(nrofPRB_{UL}*(2i−1)/2N) (3)

A center frequency of a DL TRPi can be calculated as:

F_{CenterFreTRPi_DL}=startingPRB_{DL}+floor(nrofPRB_{DL}*(2i−1)/2N) (4)

where variable i is a positive integer no greater than N. The starting physical resource block (PRB) startingPRB_{UL} is the first PRB of the active UL BWP, which is determined by higher layer parameter subcarrierSpacing of the active UL/DL BWP and another higher layer parameter offsetToCarrier corresponding to the subcarrier spacing. The starting PRB startingPRB_{DL} is the first PRB of the active DL BWP. The parameter nrofPRB_{UL} is a total number of PRBs in the active UL BWP. The parameter nrofPRB_{DL} is a total number of PRBs in the active DL BWP.

As shown in FIG. 5, the center frequency of UL TRP1 for UL BWP is the same as the center frequency of DL TRP1 for DL BWP. Similarly, the center frequency of UL TRPN for UL BWP is the same as the center frequency of DL TRPN for DL BWP. Thus, the center frequency of a UL TRP in a TRP pair matches the center frequency of a DL TRP in the TRP pair. The UL and DL TRP center frequencies may be derived from the active BWP.

Upper limit frequency point matching is detailed in the following.

With reference to FIG. 6, in an embodiment of the disclosed method, an upper limit frequency point of an UL TRPi is aligned with a TRP ID related frequency point which may be described as:

F_{UpperFreTRPi_UL}=startingPRB_{UL}+floor(nrofPRB_{UL}*(i−1)/N) (5)

An upper limit frequency point of a DL TRPi is aligned with a TRP ID related frequency point which may be described as:

F_{UpperFreTRPi_DL}=startingPRB_{DL}+floor(nrofPRB_{DL}*(i−1)/N) (6)

The term i is a positive integer no greater than N, which may be used as a TRP ID. The parameter startingPRB_{UL} is the first PRB of the active UL BWP, which is determined by higher layer parameter subcarrierSpacing of this UL/DL BWP and another higher layer parameter offsetToCarrier corresponding to this subcarrier spacing. The parameter startingPRB_{DL} is the first PRB of the active DL BWP. The parameter nrofPRB_{UL} is the total number of PRB in the active UL BWP. The parameter nrofPRB_{DL} is the total number of PRB in the active DL BWP. Thus, frequency domain resources can be allocated to the TRPs based on pre-defined frequency point of BWP, and computation complexity in generating the TRP center frequencies can be reduced.

As is shown in the FIG. 6, an upper limit frequency of UL TRP1 is aligned with the starting PRBs of the UL BWP, and an upper limit frequency of DL TRP1 is aligned with the starting PRBs of the DL BWP. Similarly, an upper limit frequency of UL TRPi is aligned with the TRP ID related frequency point, and an upper limit frequency of DL TRPi is aligned with the TRP ID related frequency point. The TRP ID related frequency point is determined based on TRP ID. For example, an DL BWP includes three DL TRPs, where an upper limit frequency of a first DL TRP in the DL BWP is startingPRB_{DL}+floor(nrofPRB_{DL}*0/N), an upper limit frequency of a second DL TRP in the DL BWP is startingPRB_{DL}+floor(nrofPRB_{DL}*1/N), and an upper limit frequency of a third DL TRP in the DL BWP is startingPRB_{DL}+floor(nrofPRB_{DL}*2/N). The startingPRB_{DL} and nrofPRB_{DL} are BWP parameters of the DL BWP. Similarly, an UL BWP includes three UL TRPs, where an upper limit frequency of a first UL TRP in the UL BWP is startingPRB_{UL}+floor(nrofPRB_{UL}*0/N), an upper limit frequency of a second UL TRP in the UL BWP is startingPRB_{UL}+floor(nrofPRB_{UL}*1/N), and an upper limit frequency of a third UL TRP in the UL BWP is startingPRB_{UL}+floor(nrofPRB_{UL}*2/N). The startingPRB_{UL} and nrofPRB_{UL} are BWP parameters of the UL BWP.

Center frequency matching with fully overlapped frequency resources is detailed in the following. A BWP, for example, is a uplink BWP including a plurality of uplink TRPs. The plurality of uplink TRPs share a same center frequency point which is the same as a center frequency point shared by a plurality of downlink TRPs in a downlink BWP. The downlink BWP includes a same identifier with the uplink BWP, and the plurality of downlink TRPs are paired TRPs of the plurality of uplink TRPs.

The frequency resources allocated for these N TRPs may be fully overlapped in the active BWP. It is proposed that the center frequency of the N UL TRPs is the same as the center frequency of the UL BWP, and the center frequency of the N DL TRPs is the same as the center frequency of the DL BWP. The center frequency of active UL BWP may be the same as the center frequency of active DL BWP. In another words, the TRP pairs, such as from UL TRP1 and DL TRP1 of TRP1, . . . , to UL TRPN and DL TRPN of TRPN, have the same center frequency. Additionally, for a dedicated TRP, the higher layer parameter CORESETPoolIndex for UL TRP of the dedicated TRP matches the higher layer parameter CORESETPoolIndex for DL TRP of the dedicated TRP. For example, the higher layer parameter CORESETPoolIndex for UL TRP of the dedicated TRP is the same as the higher layer parameter CORESETPoolIndex for DL TRP of the dedicated TRP.

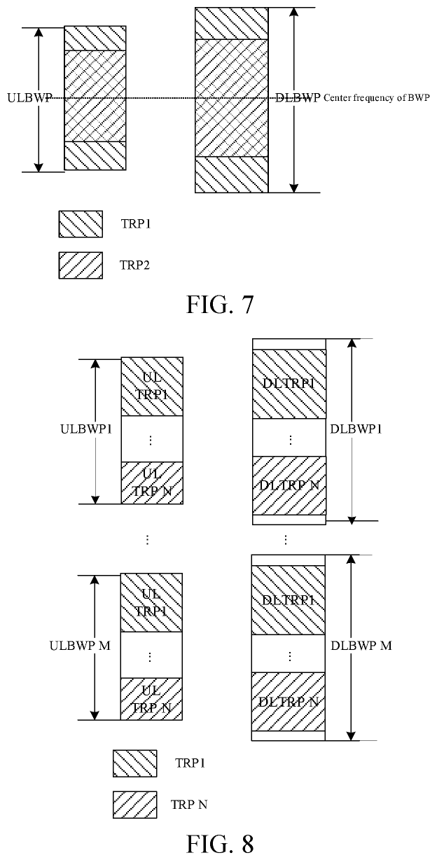

For example, as is shown in the FIG. 7, the number of TRPs is two. For a specific UL BWP, the frequency resources for UL TRP1 and UL TRP2 are fully overlapped. For a specific DL BWP, the frequency resources for DL TRP1 and DL TRP2 are fully overlapped. The TRP pairs, such as UL TRP1 and DL TRP1 of TRP1, and UL TRP2 and DL TRP2 of TRP2, have the same center frequency.

Embodiments of UL TRP ID and DL TRP ID pairing are detailed in the following.

The TRP ID is associated to the scheduling CORESET via a higher layer index CORESETPoolIndex. As N TRPs may be allocated in an active BWP, and a set of BWPs may be configured, numbering of TRP IDs. Each TRP can include an UL TRP and a DL TRP. For unpaired spectrum operation, an active UL BWP is linked with an active DL BWP. The UL TRP and DL TRP may be assigned paired TRP ID through UL TRP ID and DL TRP ID paring according to the disclosed method, and provided with available radio resources. Hence, TRP ID pairing for UL TRP and DL TRP is very essential. Two embodiments of the disclosed method for numbering the paired UL/DL TRP ID are provided in the following.

Local TRP ID pairing is detailed in the following.

In an embodiment of local TRP ID pairing, TRP IDs for DL TRPs and paired UL TRPs are numbered locally in a separate BWP. That is, TRP IDs are local parameters in an BWP, and name space of TRP IDs are not shared between BWPs. An UL TRP ID in a TRP pair is the same as a DL TRP ID in the TRP pair. Since the TRP ID may be associated with CORESETPoolIndex, which is defined per BWP, the UL TRP and the DL TRP paired with the UL TRP have the same CORESETPoolIndex. Since only N TRPs per BWP need to be configured through radio resource control (RRC) signalling, RRC resources can be saved.

As shown in FIG. 8, N TRPs are configured in a BWP, and M BWPs are configured in a cell. Specifically, each UL BWP is allocated with N UL TRPs, and each DL BWP is allocated with N DL TRPs. M is a positive integer. The TRP IDs are reused in different BWPs. Paired UL TRP and DL TRP have the same ID. Each BWP includes a plurality of TRPs with TRP identifiers being numbered as local TRP identifiers in the BWP.

Global TRP ID pairing is detailed in the following.

In an embodiment of global TRP ID pairing, TRP IDs for DL TRPs and paired UL TRPs are numbered globally across all BWPs in a cell. That is, TRP IDs are global parameters among all BWPs in a cell, and name space of TRP IDs are shared between the BWPs. Each BWP includes a plurality of TRPs with TRP identifiers being numbered as global TRP identifiers across different BWPs.

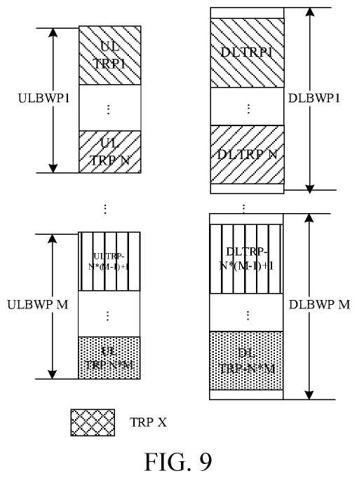

An UL TRP ID in a TRP pair is the same as a DL TRP ID in the TRP pair. As is shown in FIG. 9, if the i-th BWP is active, a paired UL TRP and a DL TRP have the same ID, such as N*(i−1)+1. Thus, each TRP has a unique ID in a cell. If a scheduler triggers BWP switching from an original BWP to a new BWP, association between TRP IDs and TRPs in both of the original BWP and the new BWP are not affected by the switching. The embodiment of global TRP pairing provides robustness during BWP switching.

UL TRP and DL TRP mapping is detailed in the following.

According to an embodiment of the disclosed method, a baseline frequency points for a paired UL TRP and a DL TRP are aligned, where the baseline frequency points may include center frequencies or upper limit frequencies of the paired UL TRP and DL TRP. A paired UL TRP and DL TRP have the same TRP ID. For unpaired spectrum operation, an active UL BWP is linked with an active DL BWP, where UL BWP index and the DL BWP index are same. With a set of BWP being pre-defined, one of the base station 200a and 200b may trigger BWP switching to improve the system performance. When a message or an event, such as bwp-InactivityTimer, DCI, an RRC signal, or medium access control (MAC) control elements (CEs) triggers BWP switching from an original BWP to a new BWP, the new BWP is active. As a consequence, the frequency domain alignment of TRP, CORESETPoolIndex pairing and TRP ID pairing should be handled in a new BWP according to the disclosed method.

When one of the base stations 200a and 200b triggers BWP switching, the new frequency points, CORESETPoolIndex and TRP IDs of an UL TRP and a DL TRP in the new BWP can be derived from the new BWP. A DL TRP with an TRP ID in the DL BWP j forms a paired TRP of an UL TRP with the same TRP ID in the UL BWP j. A DL TRP with a CORESETPoolIndex in the DL BWP j forms a paired TRP of an UL TRP with the same CORESETPoolIndex in the UL BWP j. An UL TRP with the TRP ID in the UL BWP j forms a paired TRP of a DL TRP with the same TRP ID in the DL BWP j.

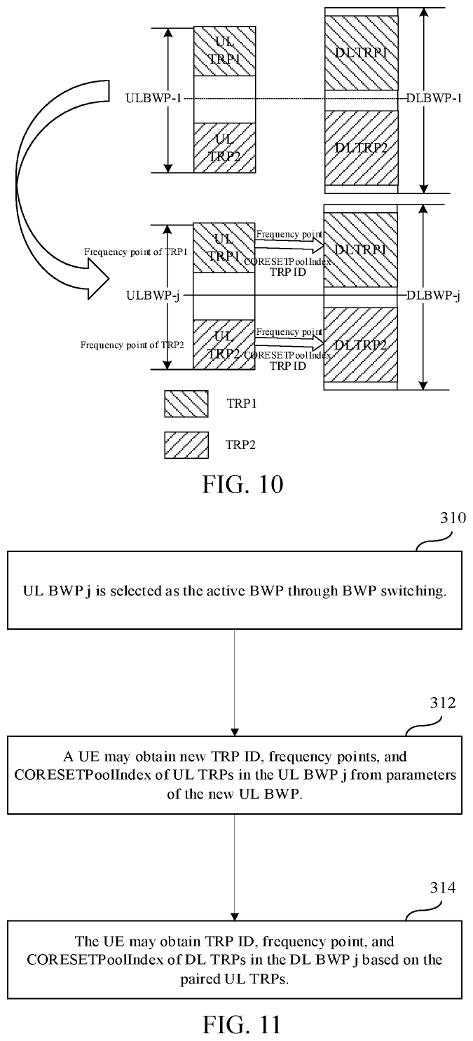

With reference to FIG. 10 and FIG. 11, the number of TRPs in each BWP is two. One of the base stations 200a and 200b triggers the UL BWP switching from first UL BWP to the j-th UL BWP. The UE determines baselines frequency points and TRP ID of UL TRPs in the j-th UL BWP and DL TRPs in the j-th DL BWP. The frequency point of DL TRP is matched with the paired UL TRP, and the DL TRP ID is the same as the parried UL TRP ID.

In the disclosed method, when UL BWP j is selected as the active BWP through BWP switching (block 310), the UE may obtain new TRP ID, frequency points, and CORESETPoolIndex of UL TRPs in the UL BWP j from parameters of the new UL BWP (block 312), and obtain TRP ID, frequency point, and CORESETPoolIndex of DL TRPs in the DL BWP j based on the paired UL TRPs according to the disclosed method (block 314). The TRP IDs of the DL TRPs in the DL BWP j are the same as TRP IDs of the UL TRPs in the UL BWP j. A baseline frequency point of each DL TRP in the DL BWP j is the same as a baseline frequency point of a paired UL TRP in the UL BWP j. A CORESETPoolIndex of each UL TRP in the UL BWP j is the same as a CORESETPoolIndex of a paired DL TRP in the DL BWP j.

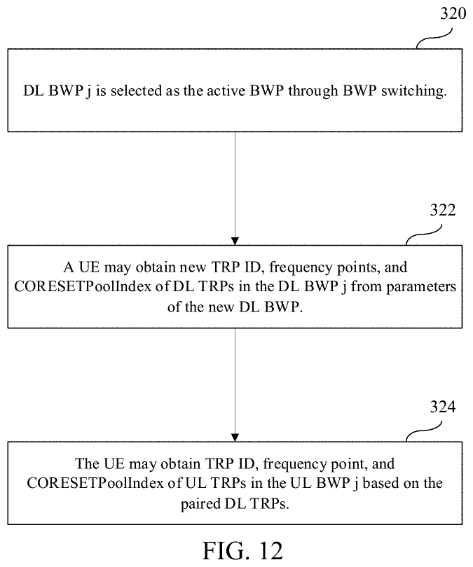

With reference to FIG. 12, when DL BWP j is selected as the active BWP through BWP switching (block 320), the UE may obtain new TRP ID, frequency point, and CORESETPoolIndex of DL TRPs in the DL BWP j from parameters of the new DL BWP (block 322), and obtain TRP ID, frequency point, and CORESETPoolIndex of UL TRPs in the UL BWP j based on the paired DL TRPs according to the disclosed method (block 324). The TRP IDs of the UL TRPs in the UL BWP j are the same as TRP IDs of the DL TRPs in the DL BWP j. A baseline frequency point of each UL TRP in the UL BWP j is the same as a baseline frequency point of a paired DL TRP in the DL BWP j. A CORESETPoolIndex of each UL TRP in the UL BWP j is the same as a CORESETPoolIndex of a paired DL TRP in the DL BWP j.

With the paring relationship, a paired TRP may monitor PDCCH in CORESET corresponding to a TRP ID of the paired TRP, and improve PDCCH decoding efficiency.

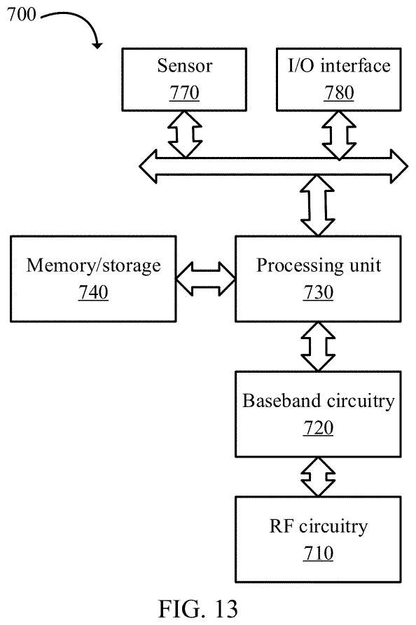

FIG. 13 is a block diagram of an example system 700 for wireless communication according to an embodiment of the present disclosure. Embodiments described herein may be implemented into the system using any suitably configured hardware and/or software. FIG. 13 illustrates the system 700 including a radio frequency (RF) circuitry 710, a baseband circuitry 720, an application circuitry 730, a memory/storage 740, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitries, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

In this disclosure, several solutions are proposed to support the uplink transmission, which include uplink TRP ID identification, frequency domain alignment for uplink and downlink TRP, UL/DL TRP ID pairing and TRP mapping. First of all, by defining a method to identify the uplink TRP ID, the UE can start the uplink procedures. Secondly, for unpaired spectrum operation, three methods are proposed to handle the problem of frequency domain misalignment between UL TRP and DL TRP. Thirdly, regarding multiple TRPs in a cell, two solutions are proposed to number the TRP ID and the paired TRPs have the same ID. Finally, when the gNB triggers the BWP switching, the frequency point and TRP ID of the paired TRP can be immediately derived from a new BWP, which guarantees that the paired TRP is provided with the available resource. Taking these methods into consideration, the support for uplink transmission in multi-DCI based multi-TRP transmission is greatly enhanced.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. An uplink processing method for multiple transmission and reception point (TRP) based communication,
executable by a user equipment, comprising:
receiving parameters of a bandwidth part (BWP) in a serving cell;
obtaining a frequency point of one of a paired uplink TRP and a downlink TRP from the parameters of BWP; and
obtaining a frequency point of the other one of the paired uplink TRP and the downlink TRP from the frequency point of one of a paired uplink TRP and a downlink TRP.

2. The method of claim 1, wherein the paired uplink TRP and the downlink TRP have a same TRP identifier.

3. The method of claim 2, wherein the paired uplink TRP and the downlink TRP have a same ControlResourceSet (CORESET) group index.

4. The method of claim 3, wherein the paired uplink TRP and the downlink TRP have a same higher layer parameter CORESETPoolIndex.

5. The method of claim 1, wherein a center frequency point of the uplink TRP in the paired uplink TRP and the downlink TRP is the same as a center frequency point of the downlink TRP in the paired uplink TRP and the downlink TRP.

6. The method of claim 5, wherein a center frequency point of the uplink TRP in the paired uplink TRP and the downlink TRP is:
F_{CenterFreTRPi_UL}=startingPRB_{UL}+floor(nrofPRB_{UL}*(2i−1)/2N)
where N is a total number of TRPs in the BWP, variable i is a positive integer no greater than N, nrofPRB_{UL} is a total number of physical resources blocks in the active UL BWP, and startingPRB_{UL} is a first PRB of the BWP.

7. The method of claim 1, wherein an upper limit frequency point of the uplink TRP in the paired uplink TRP and the downlink TRP is aligned with the UL TRP ID related frequency point.

8. The method of claim 7, wherein an upper limit frequency of the uplink TRP in the paired uplink TRP and the downlink TRP is:
F_{UpperFreTRPi_UL}=startingPRB_{UL}+floor(nrofPRB_{UL}*(i−1)/N)
where N is a total number of TRPs in the BWP, variable i is a positive integer no greater than N, nrofPRB_{UL} is a total number of physical resources blocks in the active UL BWP, and startingPRB_{UL} is a first PRB of the BWP.

9. The method of claim 1, wherein an upper limit frequency point of the downlink TRP in the paired uplink TRP and the downlink TRP is aligned with the DL TRP ID related frequency point.

10. The method of claim 9, wherein an upper limit frequency of the downlink TRP in the paired uplink TRP and the downlink TRP is:
F_{UpperFreTRPi_DL}=startingPRB_{DL}+floor(nrofPRB_{DL}*(i−1)/N)
where N is a total number of TRPs in the BWP, variable i is a positive integer no greater than N, nrofPRB_{DL} is a total number of physical resources blocks in the active DL BWP, and startingPRB_{DL} is a first PRB of the BWP.

11. The method of claim 1, wherein the BWP is selected as an active BWP through BWP switching.

12. The method of claim 1, wherein the BWP is a uplink BWP comprising a plurality of uplink TRPs, the plurality of uplink TRPs share a same center frequency point which is the same as a center frequency point shared by a plurality of downlink TRPs in a downlink BWP, the downlink BWP comprises a same identifier with the uplink BWP, the plurality of downlink TRPs are paired TRPs of the plurality of uplink TRPs, and higher layer parameters CORESETPoolIndex for the uplink TRPs match the higher layer parameters CORESETPoolIndex for the downlink TRPs.

13. The method of claim 1, wherein the BWP comprises a plurality of TRPs with TRP identifiers being numbered as local TRP identifiers in the BWP.

14. The method of claim 1, wherein the BWP comprises a plurality of TRPs with TRP identifiers being numbered as global TRP identifiers across different BWPs.

15. An apparatus comprising:
a transceiver; and
a processor connected with the transceiver and configured to execute the following steps comprising:
receiving parameters of a bandwidth part (BWP) in a serving cell;
obtaining a frequency point of one of a paired uplink TRP and a downlink TRP from the parameters of BWP; and
obtaining a frequency point of the other one of the paired uplink TRP and the downlink TRP from the frequency point of one of a paired uplink TRP and a downlink TRP.

16. The apparatus of claim 15, wherein the paired uplink TRP and the downlink TRP have a same TRP identifier.

17. The apparatus of claim 16, wherein the paired uplink TRP and the downlink TRP have a same ControlResourceSet (CORESET) group index.

18. The apparatus of claim 17, wherein the paired uplink TRP and the downlink TRP have a same higher layer parameter CORESETPoolIndex.

19. The apparatus of claim 15, wherein a center frequency point of the uplink TRP in the paired uplink TRP and the downlink TRP is the same as a center frequency point of the downlink TRP in the paired uplink TRP and the downlink TRP.

20. The apparatus of claim 17, wherein a center frequency point of the uplink TRP in the paired uplink TRP and the downlink TRP is:
F_{CenterFreTRPi_UL}=startingPRB_{UL}+floor(nrofPRB_{UL}*(2i−1)/2N)
where N is a total number of TRPs in the BWP, variable i is a positive integer no greater than N, nrofPRB_{UL} is a total number of physical resources blocks in the active UL BWP, and startingPRB_{UL} is a first PRB of the BWP.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)
